(19) United States
(12) Patent Application Publication
(10) Pub. No.: US 2002/0062225 A1
(43) Pub. Date: May 23, 2002

(54) PERSONAL HEALTH CENTER

(76) Inventor: VLAD SIPERCO, WILLOWDALE (CA)

Correspondence Address: GOWLING, LAFLEUR & HENDERSON LLP, 160 ELGIN STREET, SUITE 2600, OTTAWA, ON, K1P 1C3, CA

(21) Appl. No.: 09/343,395

(22) Filed: Jun. 30, 1999

(51) Int. Cl. G06F 17/60

(52) U.S. Cl. 705/2

(57) ABSTRACT

A method and a system for monitoring the health of an individual are provided. The system includes a personal health center having a communication module for connection to a remote medical database through a network. The method comprises the steps of storing in a personal health/wellness database personal health and wellness data including transferring to the personal health/wellness database medical data from the remote medical database, inputting additional wellness data, and generating a wellness report by compiling data from the personal health/wellness database according to a health risk factor of interest. The personal health/wellness database may be a personal computer health/wellness database, a personal health/wellness server space, or the like.

The present invention advantageously enables an individual to be in control and to update medical information concerning his/her wellness by assembling personal medical data stored by various medical care providers in a personal health/wellness database.

### BACKGROUND OF THE INVENTION

1. Field of the Invention

The present invention generally relates to collecting and processing medical care data and in particular to a personal health center having a unique health/wellness database.

2. Related Art

Today, health care costs are a priority for every business. More than 50% of health care costs are lifestyle related. Statistics also show that about 80% of the population in North America is concerned with their optimal health and fitness level. Health scientists are continuously searching information and data for creating a scientific wellness and optimal body chemistry data base. The availability of personal computers has made possible to store and use these data to address questions regarding individual optimal health.

The allopathic medicine is generally crisis-oriented. Typically, individuals visit a doctor when they are in need for help. Accordingly, doctors are trained to cut rather than heal, and fix rather than prevent. Prevention and early detection of diseases becomes an important part of our life as medicine evolves towards trying to solve medical problems by exploring their origins. Access to massive quantities of patient data to allow generation of medical record summaries becomes important for the wellness of an individual.

U.S. Pat. No. 5,846,263 issued on Dec. 1, 1998, to Rensimer Enterprises, Ltd., discloses a system and method for accurately processing patient data including the medical history and the level of examination of the patient, the decision making process of the physician treating the patient, and the time influence factor. The medical care data is recorded, saved, and transferred from a portable system to a database system for automatically generating a clinical status code and saving physician time. Based on the accumulated medical data, the system quantifies the physician intervention status as a measure of the physician's rendered level of care.

U.S. Pat. No. 5,823,948 issued on Oct. 20, 1998, to RLIS, inc., shows a medical record, documentation, tracking and order entry system with automatic incorporation of dictated text. Most information is stored as data, not as text, allowing simultaneous access and input to the same chart. Remote access to the database by consulting physicians is allowed with strict maintenance of patient records confidentiality. Reports on individual patients including patient records, doctor related activities, nursing related activities and patient statistics may be immediately generated and supplied to physicians.

Historically, the information was flowing from medical service providers (doctors, labs, etc.) and individuals to medical databases in hospitals, clinics, or the like. There is a need for allowing an individual to access personal medical data from medical databases located at the medical service providers. This personal medical data may be stored and continuously updated in a patient personal health/wellness database

### SUMMARY OF THE INVENTION

It is an object of the present invention to provide a method and system for monitoring one's wellness status.

It is another object of the present invention to provide an individual with access to own's medical information already stored by entities providing medical care, to retrieve and to store personal medical data in a personal health/wellness database. The personal health/wellness database can be further updated at any given time with personal and confidential information related to a significant health event.

Another object of the present invention is to allow an individual to generate at any given time a complete personal medical/wellness report which can be presented to a physician, or can be compared with a pre-established health plan for suggesting corrective strategies to the individual.

According to one aspect of the invention a method for management of personal medical and wellness records is provided. The method comprises the steps of storing in a personal health/wellness database personal health and wellness data including transferring to the personal health/wellness database medical data from a remote medical database, inputting additional wellness data, and generating a wellness report by compiling data from the personal health/wellness database according to a health risk factor of interest. The personal health/wellness database may be a personal computer health/wellness database, a personal health/wellness server space, or the like.

The present invention advantageously enables an individual to be in control and to update medical information concerning his/her wellness by assembling personal medical data stored by various medical care providers in a personal health/wellness database. Moreover, personal and confidential information relative to characteristic and uncharacteristic health related events that have an effect on one's wellness may be added to the recorded medical data. A reliable and original medical/wellness data collection is therefore created.

The personal health center may be accessed from home or remotely, and can supply wellness reports at any given moment, without delaying or burdening hospital personnel. The reports can be presented to other physicians for obtaining a second opinion. The system has the capability to generate medical alerts related to scheduled medical/wellness activities.

### BRIEF DESCRIPTION OF THE DRAWINGS

The present invention will be now explained by way of example only and with reference to the following drawings:

FIG. 1 is an illustration of one embodiment the personal health monitoring system according to the invention;

FIG. 2 is a chart of the personal health/wellness database of FIG. 1, and

FIGS. 3a, 3b, 3c, show examples of menus displayed by the system of FIG. 1.

Similar references are used in different drawings to denote similar components.

### DETAILED DESCRIPTION OF THE PREFERRED EMBODIMENTS

Typically, the flow of information in the medical field is directed from patients to physicians, hospitals, or other medical/wellness service providers. The medical data are collected in electronic and/or hand-held files. A patient may have a plurality of such files distributed between various locations according to medical service provider locations. In theory, copies of these files are exchanged between health care providers, but in reality this transfer may be a complicated one. For example a medical second opinion or a visit to a specialist are based on partial data selected by the general practitioner.

The present invention changes the direction of the flow, by allowing individual access to one's records in all medical databases using a personal computer and a communications module for connection through a network to the already established medical databases. A unique personal health center is created with a personal health/wellness database which can be updated as health related situations happen in one's life. Furthermore, the individual can dispose of his/her records as he/she pleases.

According to the invention, the whole information relative to a patient is collected in a personal health/wellness database which can be accessed by authorized persons only. These authorized persons, or collecting persons, are also able to follow in real time any medical developments for a target person receiving in-patient or out-patient services. This relieves the hospital from the burden of answering numerous health related calls, saves time, and enhances the state of mind of the collecting/authorized persons.

Throughout the description the words “individual” and “patient” are used interchangeably. A person in charge of an individual's health, or a collecting person, is a person monitoring the individual's health and is not necessarily a doctor. For example, parents may be the collecting persons for a child.

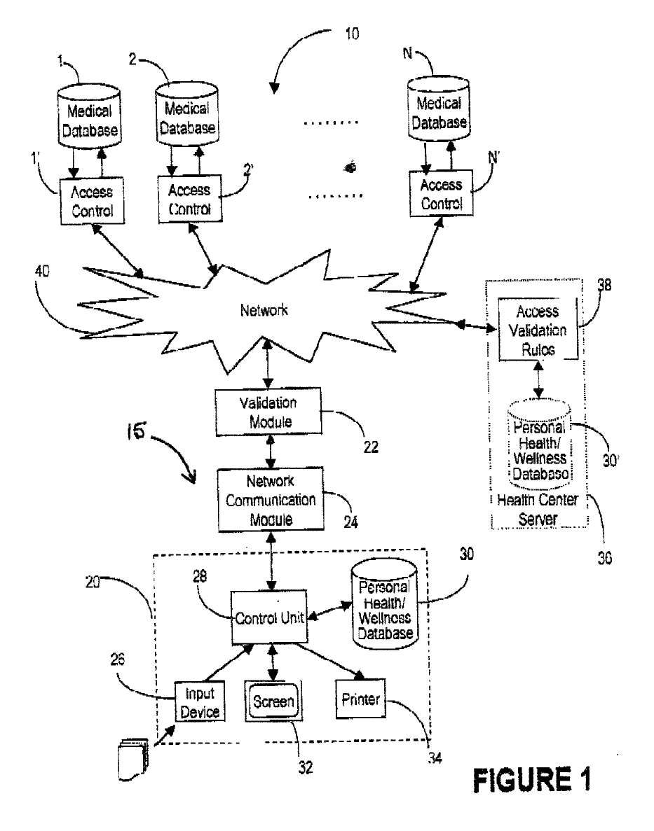

FIG. 1 shows a personal health monitoring system 10 for accessing and transferring medical information from entities 1, 2, . . . N, to a personal health/wellness database 30 or 30′. The entities 1, 2, . . . N, are generally medical care service providers storing medical records in dedicated medical databases. According to the invention, one individual can access any database located at any medical care service provider location via a data terminal 20.

Terminal 20 includes a control unit 28, a personal medical/wellness database 30, an input device 26, screen 32, printer 34, a network communication module 24, and a validation module 22. The network communication module 24 is an interface providing access to network 40, under the control of the validation module 22. Data terminal 20 may be a personal computer or the like.

Terminal 20 can transfer medical data from remote medical databases 1, 2, . . . N to a personal health/wellness database 30 or 30′ over network 40, and can be also used to manually input personal wellness and health information using input device 26, and to generate wellness reports by compiling information collected in database 30 or 30′ A report can be displayed on screen 32 or can be printed on printer 34. A personal health center 15 comprises terminal 20, network communication module 24, and validation module 22.

Validation module 22 is provided to prevent access to personal medical data accumulated in medical databases 1, 2, N by unauthorized persons. The validation process may imply the use of a security card, a password, a voice recognition process, a digital signal algorithm, a fingerprint verifier, or any similar processes known in the art and capable to identify and validate an authorized user. The personal health center 15 can download information from databases 1, 2, . . . N as long as the user has been approved, and will disconnect access to the patient's file after a negative validation, or after a predetermined time has expired.

As shown in FIG. 1, the personal health/wellness database 30 or 30′ may be located in one's personal computer 20, as for example database 30, and/or in a server storage space 30′ allocated to an individual on a health center server 36. The personal health/wellness database 30 or 30′ is created by any interested individual for storing all personal medical data and wellness information, and can be constantly updated using input device 26. The medical data can be accessed and transferred from medical databases 1, 2, . . . N as they become available.

An individual can remotely update the health/wellness information on server 36. Access to server 36 could be direct or over Internet. Internet may also be used for downloading relevant information. For example, a drug prescribed by a physician may be selected for a query and run on a site that provides this particular type of information and the results may be stored in the personal health/wellness database 30 or 30′. The medical data may be accessed and transferred from medical databases 1, 2, . . . N to personal health/wellness database 30′ under the control of terminal 20. Alternatively, the medical data can be automatically transferred to database 30′ under the control of the medical care provider.

As shown above, the information can be pulled or pushed based on existing agreements between the service providers of medical databases 1, 2, . . . N, health center server 36, network 40, and the individual. When it is pulled from medical databases 1, 2, . . . N, the information is transferred to the personal computer 20 or to the personal health/wellness server 36 under control of unit 28, and stored in the respective personal health/wellness database 30 or 30′, respectively. When it is pushed, the information is automatically transferred from databases 1, 2, . . . N, to the personal health/wellness database 30′.

Access control modules 1′, 2′, . . . N′ are used by the medical service provider to validate access to their databases 1, 2, . . . N only to approved users. As well, when the information is stored on a personal health/welness database 30′, the access to information has to be validated through an access and validation rules unit 38, according to the medical information confidentiality rules.

It is to be noted that a personal health/wellness database 30 or 30′ can also be remotely accessed. When a user connects to a distant destination through a router, the user's source as well as the destination addresses must be validated in a router access control list.

The medical data may be received from physicians, labs, hospitals, chiropractors, or other medical service provider databases 1, 2, . . . N through an electronic transfer. On request, the medical data can be automatically transferred from the medical care providers 1, 2, . . . N to the personal medical/wellness database 30 or 30′. In the case where a collecting person is to receive the medical data, the patient has to indicate the address and the name of this collecting person, where the information is to be transferred. The address may be an Internet address, a server with one or more databases, an e-mail address, etc. The frequency of information transfers as well as the content e.g. diagnostics only; diagnostics and lab results, etc., can be agreed upon between the individual and the respective medical service provider in charge with the medical databases 1, 2, . . . N.

An authorized individual can also request copies and input personal medical data into the personal health/wellness database 30 or 30′ using the input device 26, (i.e. a keyboard, voice, document scanning).

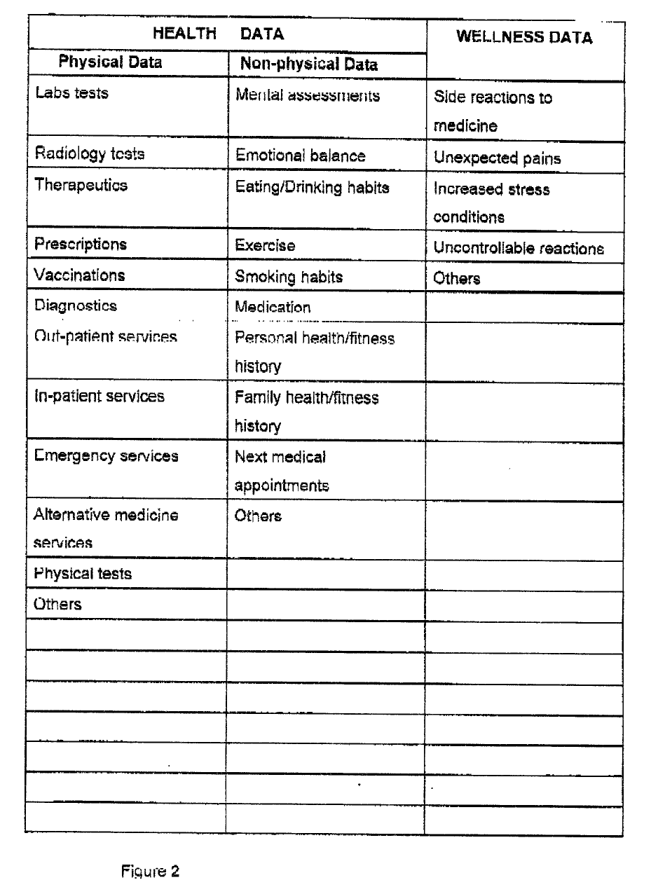

As shown in FIG. 2 by way of example, the information stored in the database 30 or 30′, may include health and wellness data. The health data include the medical data routinely stored in databases 1, 2, . . . N, as well as additional health information collected by the user and inputted manually, as this becomes available.

The health data can be generally divided in physical and non-physical data. Examples of physical data are labs results, radiology, therapeutics, prescriptions, vaccinations, diseases and the respective diagnostics, out-patient and in-patient services used by this individual, emergency services, psychological tests, alternative medicine services, physical tests results. These information is defined as physical data as it can be objectively measured.

Examples of non-physical data are lifestyle information, mental/emotional balance, eating/drinking habits, data relating to physical activities such as exercise. Smoking habits, past and present non-prescription medication, personal health and fitness history, family health and fitness history can also be stored as non-physical data. Non-physical data can be scientifically assessed. As seen above, physical as well as non-physical data may be manually inputted or electronically transferred from other databases.

The wellness data, or personal health and wellness entries are associated with special health/wellness episodes like newly discovered side reaction to a medication, unexplained pains and uncomfortable feelings, uncommon stress conditions, uncontrollable reactions, all of which are manually inputted by the individual as they occur. Usually these episodes are forgotten and never presented to a physician to be evaluated.

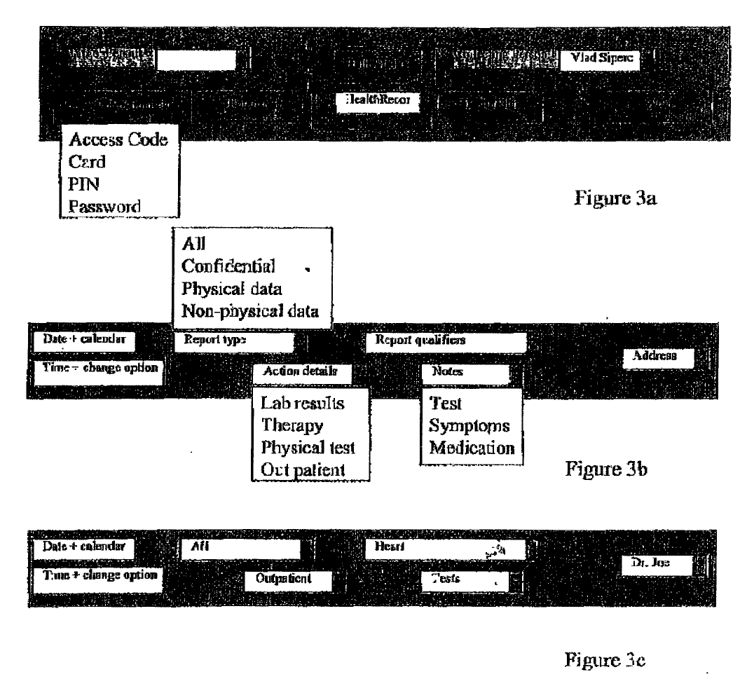

FIGS. 3a, 3b, 3c, show examples of menus displayed on screen 32 of terminal 20. As indicated above, this menus may be pulled down by an authorized individual, i.e. the patient, or the collecting person. As shown in FIG. 3a, database 30 or 30′ can be accessed only after a validation process.

The information stored in personal health/wellness database 30 or 30′ can be retrieved in the form of a wellness report including medical data, lifestyle information, and/or personal health and wellness entries, as indicated above. Printing options are presented in a menu as shown in FIG. 3b, for generating the report in the desired format and having the required content. The information may be arranged and presented according to a preselected report type format, having texts formatted to the appropriate output with the medical records printed in a typeset format.

On his own initiative, or following medical suggestions, the user can flag and corroborate information characteristic to a health risk factor, or a health condition of concern. The health risk factor may be selected by the physician or by the individual and can be rated low, moderate, or high. For example, a simple key word search can be performed for collecting all data stored and including the health aspect of interest. The health risk factor may be a symptom, a medication related matter, a disease, temporary psychological disorders, intriguing lab and/or physical test results, or combinations thereof. A wellness report can be finally generated based on the respective health risk factor of interest.

The information in the report may be partial, i.e. prescriptions only; symptoms only, etc. FIG. 3c, illustrates the screen for an individual willing to retrieve from all the information stored personal health/wellness database 30 or 30′ the health/wellness information related to his heart as characterized by all the tests performed as an out-patient. It is to be noted that a full wellness report may be generated at any time.

The wellness report may be typed or electronically transmitted to other physician/s for obtaining a second medical opinion. The report may be also compared with a health plan established according to a wish list created by the patient or by the doctor.

The personal health center 15 can provide alerts whenever a medical action is required e.g. administration of medicine, vaccine, etc. Alerts can also be generated based on a comparison between the pre-established health plan and the actual wellness report.

Numerous modifications, variations, and adaptations may be made to the particular embodiments of the invention without departing from the scope of the invention as defined in the appended claims.

1. A method of management of personal medical records, comprising:
storing health/wellness data in a personal health/wellness database;
transferring to said personal health/wellness database medical data from a remote medical database; and
generating a wellness report by compiling data from said personal health/wellness database based on a health risk factor.

2. The method of claim 1, wherein said step of storing health/wellness data includes the step of inputting personal health and wellness entries.

3. The method of claim 1, wherein said step of transferring medical data includes the steps of:
validating access to said medical database; and
authorizing said access only to personal medical data.

4. The method of claim 1, wherein said step of generating further comprising:
comparing said wellness report with a pre-established health plan; and
originating alerts whenever a difference is detected between said wellness report and said pre-established health plan.

5. The method of claim 1, wherein said health risk factor is selected from the group consisting of symptoms, effect of medication, diseases, alarming labs and physical tests results, and combinations thereof.

6. A personal health monitoring system, comprising:
a data terminal for creating, maintaining, and updating a personal health/wellness database with medical and wellness data;
a network communication module for connecting said data terminal to a remote medical database containing a plurality of files; and
a validation module for authorizing access to a file in said medical database.

7. The system of claim 6, wherein said health/wellness database is a personal storing space located on a health center server.

8. The system of claim 6, wherein said data terminal has means for inputting health and wellness data, and output means for generating a wellness report.

9. The system of claim 8, wherein said wellness report is generated by compiling data stored in said health/wellness database based on a health risk factor.

10. The system of claim 6, wherein said medical database further comprises an access control module for cooperating with said validation module and authorizing transfer of said medical data contained in said file to said personal health/wellness database.

11. A medical database, comprising:
means for storing medical data accumulated by a medical service provider and arranged in a plurality of files; and
an access control module for validating remote access to said medical database and authorizing only transfer of data comprised in a file.

12. A health center system, comprising:
a medical database having means for storing medical data accumulated by a medical service provider and arranged in a plurality of files, and an access control module for validating remote access to said medical database and authorizing access to a file; and
a personal health center comprising a data terminal for creating, maintaining, and updating a personal health/wellness database with health and wellness data, a network communication module for connecting said data terminal to said medical database, a validation module for cooperating with said access control module and authorizing transfer of said medical data from said file to said personal health/wellness database, means for inputting health and wellness data, and output means for generating a wellness report by compiling data stored in said health/wellness database based on a health risk factor.
